(19) United States
(12) Patent Application Publication
(10) Pub. No.: US 2026/0335189 A1
(43) Pub. Date: Oct. 29, 2026

(54) Support for a flexible bag containing liquid medication, flexible bag unit, and medication delivery device

(71) Applicant: SHL Medical AG, Zug (CH)

(72) Inventors: Martin Michael Coyne, III, Boonton, NJ (US); Katherine Ford Brigham, Boonton, NJ (US); Christopher James Franzese, Boonton, NJ (US); Jacob Leon Turetsky, Norwalk, CT (US); Yukiko Naoi, Norwalk, CT (US); Jeffrey Kapec, Norwalk, CT (US); Núria De Santiago Giner, Zug (CH); Christoph Egloff, Zug (CH); Samuel Wyler, Zug (CH); Lukas Bannwart, Zug (CH); Matthew Connor D'Auria, Boonton, NJ (US)

(21) Appl. No.: 19/107,333

(22) PCT Filed: Aug. 31, 2023
(86) PCT No.: PCT/EP2023/073977

§ 371 Date: Feb. 27, 2025

Related U.S. Application Data
(60) Provisional application No. 63/403,071, filed on Sep. 1, 2022.

(30) Foreign Application Priority Data
Oct. 13, 2022 (EP) 22201346.8

(51) Int. Cl. A61J 1/16; A61J 1/10

(52) U.S. Cl. CPC A61J 1/16; A61J 1/10; A61J 2205/60

(57) ABSTRACT

It is provided a support for a flexible bag, said flexible bag having an inner space to accommodate a volume of liquid medication, the support i) being adapted to fixedly couple to and tightly hold at least one side of the flexible bag, ii) comprising an outlet connectable with an external tube, and a flow path which can fluidly communicate the inner space of the flexible bag with the outlet when said flexible bag is being coupled to the support, and iii) extending to fully cover and thus protect at least one side of the flexible bag, the support allowing at least a part of the flexible bag to be visible when said flexible bag is being coupled to the support.

The present disclosure is directed to a support for a flexible bag or container containing liquid medication, a flexible bag unit comprising the support together with the flexible bag, and a medication delivery device comprising the flexible bag unit together with a housing containing the flexible bag unit and a fastening means for fixing the housing to the body of a patient.

Flexible bags have many advantages as reservoirs for liquid parenteral medications. They may be provided with a variety of fills and volumes, accommodating patient specific (e.g., weight-based or body surface area-based) doses, dose banded medications (e.g., where a discrete number of fixed doses are provided for a variety of different patients), as well as fixed doses (i.e., wherein all patients receive the same dose). Additionally, through careful material construction, flexible bags may be provided with extended stability, through co-laminating materials that provide both excellent drug contact properties (i.e., low extractable/leachable) and barrier properties against undesired oxygen or water vapor transmission.

However, flexible bags also have shortcomings. Especially outside the clinical setting, flexible bags may be prone to rupture if excessive pressure is applied. This may take place when a patient places pressure inadvertently on the bag, as through sitting on it or rolling over on it. Additionally, handling may place excessive flexure and apply unanticipated stress on the heat seal that holds laminate layers together and seals the bag. Such stress may cause loss of container closure (e.g., sterility) or loss of drug product, as through leakage.

Flexible bags such as those disclosed in WO 2012/175465A1, hereinafter called Weibel bag(s), have an improved structure strengthening a header portion of the bag. However, some conventional flexible bags may still be vulnerable to rupture.

WO 2018/083530 A1 provides a protecting package for a flexible bag to prevent such rupture. The protecting package includes two protective pads sandwiching the flexible bag. Even though this protecting package may provide sufficient protection for the flexible bag to prevent rupture of the bag, the structure of the package is inappropriate to be mounted inside a medication delivery device. Further, since the protective pads cover most of surfaces of the flexible bag and are connected to each other along all sides of the flexible bag, it is hard to visually inspect a state of liquid medication in the flexible bag prior to use, during delivery, and/or after delivery is complete. Visual inspection may be a regulatory or patient safety requirement to approve a medicament contained in such a flexible bag.

Loading in or connection of conventional flexible bags to a medication delivery device is also unintuitive, especially to an untrained user, even if the flexible bag outline is shaped or contoured to provide orientation cues. Such features may also increase manufacturing complexity, necessitating different bag designs for different drug delivery devices.

Further, conventional flexible bags may take different shapes as it is filled to different volumes. This may lead to unpredictable expansion and difficulty fitting a filled bag into a drug delivery device.

Thus, improvements to flexible bag design are needed to provide reliable structural support for filling operations and carrying of the flexible bag, to facilitate inspection of filled flexible bags, to improve orientation enabling loading into a drug delivery device, and to avoid situations that compromise structural integrity of the bag once filled. Moreover, these improvements should be implemented in a way that does not compromise either manufacturing or filling workflows and efficiency.

The present invention defined by the appended claims solves the above-identified problems.

Specifically, the present invention provides a reliable structural support for a flexible bag to protect rupture of the flexible bag due to excessive pressure. This support may reinforce or make substantially rigid at least a portion of the flexible bag when the flexible bag is coupled to the support. The present invention also provides a flexible bag unit comprising this reliable structural support together with a flexible bag for the same purpose.

The present invention provides a support for a flexible bag, which enables easy visual inspection of liquid medication in the flexible bag. Preferably, visual inspection is enabled by allowing more than 50% of the bag to be exposed for visual inspection prior to use, during delivery, and/or after delivery is complete. The present invention also provides a flexible bag unit comprising this support together with a flexible bag for the same purpose.

The present invention provides a support for a flexible bag, which enables ease of assembly of filled medication bags together with the support to constitute a flexible bag unit.

The present invention provides a support for a flexible bag, which facilitates easy correct loading of the support together with the flexible bag within a medication delivery device based on structural and/or orientational features of the support. For the same purpose, the present invention also provides a flexible bag unit containing this support together with the flexible bag, and/or a medication delivery device containing the flexible bag unit.

The present invention provides a support for a flexible bag, which enables correct use of medication in the flexible bag when the support together with the flexible bag is loaded in a medication delivery device based on information obtainable from the support. For the same purpose, the present invention also provides a flexible bag unit containing this information-containing support together with the flexible bag, and/or a medication delivery device containing this information-containing flexible bag unit.

The present invention provides a support for a flexible bag, a shape of which changes as a remaining amount of liquid medication in the flexible bag changes. This shape-changing support enables users to easily notice current progress of medication delivery, and the resilient characteristic of the support can work as a squeezing force for delivering the medication with pressure.

In the following description, there is provided a support for a flexible bag having an inner space to accommodate a volume of liquid medication, the support i) being adapted to fixedly couple to and tightly hold at least one side of the flexible bag, ii) comprising an outlet connectable with an external tube, and a flow path which can fluidly communicate the inner space of the flexible bag with the outlet, and iii) extending to cover and thus protect at least one side of the flexible bag, the support being shaped having a visible area which allows reliable inspection of the entire volume of medication in the flexible bag prior to use, during delivery, and/or after delivery is complete when located in a medication delivery device.

According to the invention, there is provided a support for a flexible bag, said flexible bag having an inner space to accommodate a volume of liquid medication, the support i) being adapted to fixedly couple to and tightly hold at least one side of the flexible bag, ii) comprising an outlet connectable with an external tube, and a flow path which can fluidly communicate the inner space of the flexible bag with the outlet when said flexible bag is being coupled to the support, and iii) extending to fully cover and thus protect at least one side of the flexible bag, the support allowing at least a part of the flexible bag to be visible when said flexible bag is being coupled to the support.

Preferably, the support is shaped for allowing either one or both of a first surface and an opposite second surface of the flexible bag to be visible. Preferably, the support is partially transparent i.e., some parts are made of transparent material, and/or is shaped for allowing more than 50% of either one or both of a first surface and an opposite second surface of the flexible bag to be visible.

Preferably, the support may comprise a support head having the outlet and the flow path; and a support body extending from the support head toward other side or sides of the flexible bag than the at least one side of the flexible bag to cover and thus protect the flexible bag.

Preferably, the support body may comprise a first support body and a second support body spaced from each other. The flexible bag may be disposed between the first support body and the second support body.

Preferably, the support may further comprise a support leg connecting the first support body and the second support body. The support leg may be arranged to cover or substantially enclose a side of the flexible bag.

Preferably, the support body may comprise a lower support body supporting the flexible bag on one side of the flexible bag.

Preferably, the support may further comprise a support leg connected to the lower support body and arranged to cover or substantially enclose a side of the flexible bag.

Preferably, a width of the support body may be smaller than that of the support head. Preferably, the support head or the support body may have a cross-section of a ‘U’ shape to partially cover both the first surface and the opposite second surface of the flexible bag.

Preferably, the rigidity of the support body may be lower than that of the support head such that the support body is rollable towards and away from the support head, preferably as a volume of medication in the flexible bag changes.

Preferably, at least a portion of the support body may be made from a flexible material.

Preferably, the support may comprise a first support and a second support coupled to each other. The first and second supports may be adapted to receive the flexible bag in between. The first and second supports may be coupled to each other by means of a hinge.

Preferably, the support body may comprise a first frame part and a second frame part connected each other such that a length of the support body is variable by a relative movement between the first and second frame parts as a volume of liquid medication in the flexible bag changes.

Preferably, the first frame part may be resiliently connected to the second frame part so that the support body has a contracted position and an expanded position.

Preferably, the support may further comprise a tube connected to the outlet and a needle connected to the tube for supplying the liquid medication to patients.

Preferably, one or more out of the outlet, the tube and the needle are arranged asymmetrically relative to the support head to indicate an orientation of the support.

Preferably, the support may comprise an electronic tag containing information relating to a flexible bag which can be assembled with the support, or the medication filled in the flexible bag; and/or a geometry which can be used for locating the support at a particular position in a medication delivery device or which encodes said information.

In the following description, there is further provided a flexible bag unit comprising the support explained above and a flexible bag.

Preferably, the flexible bag may comprise at least two layers of flexible films sealed at the boundary thereof to form an inner space to accommodate liquid medication, wherein the at least two layers of flexible films constitute a first surface and a opposite second surface of the flexible bag, respectively.

Alternatively, the flexible bag may comprise at least one layer of flexible film and at least one layer of non-flexible material sealed to the at least one layer of flexible film to form an inner space to accommodate liquid medication, wherein the at least one layer of flexible film and the at least one layer of non-flexible material constitute a first surface and an opposite second surface of the flexible bag, respectively.

Preferably, for instance in case that the support does not comprise an electronic tag, the flexible bag may comprise an electronic tag containing information relating to the flexible bag or the medication filled in the flexible bag.

In the following description, there is further provided a medication delivery device, preferably a reusable and/or wearable medication delivery device, comprising the flexible bag unit explained above; and a housing comprising one or more spaces for accommodating the at least one flexible bag unit, a cover to cover or close the one or more spaces, and a coupling portion which is connectable to a fastener for fixing the housing to a body part of a patient. The medication delivery device may also be disposable and wearable.

Preferably, the medication delivery device may be configured to: i) obtain information, by communication with the electronic tag or detection of the geometry, on presence/absence of the flexible bag unit in the device, proper installation of the flexible bag unit in the device, or the flexible bag unit contained in the medication delivery device, and ii) control the device based on the obtained information.

Preferably, the information on the flexible bag unit may comprise: the capacity of the flexible bag unit in the device, an amount of the medication in the flexible bag, one or more parameters associating a medication in the flexible bag with a patient receiving medication with the medication delivery device, or one or more parameters for delivery of the medication to patient.

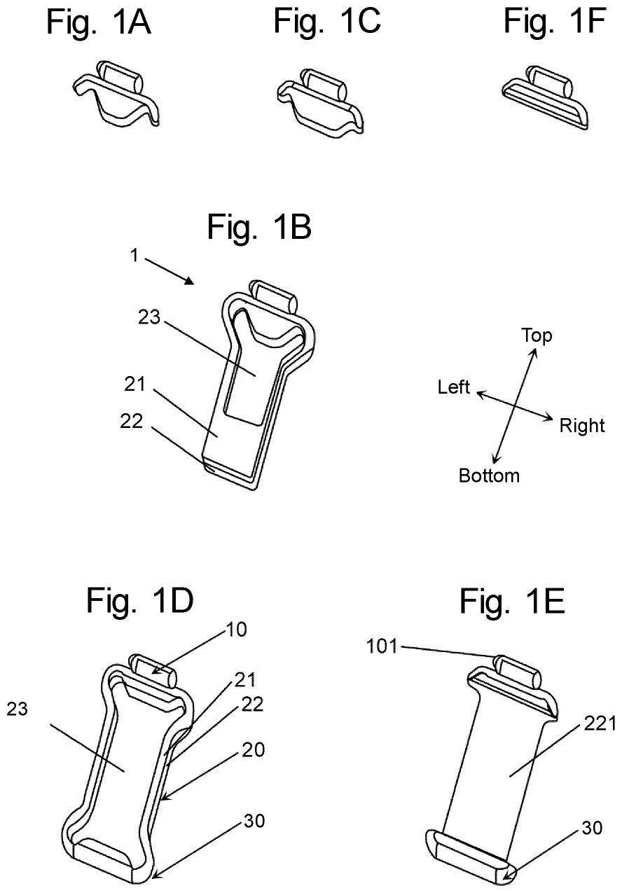

FIGS. 1A to 1E are perspective views of different supports according to the invention.

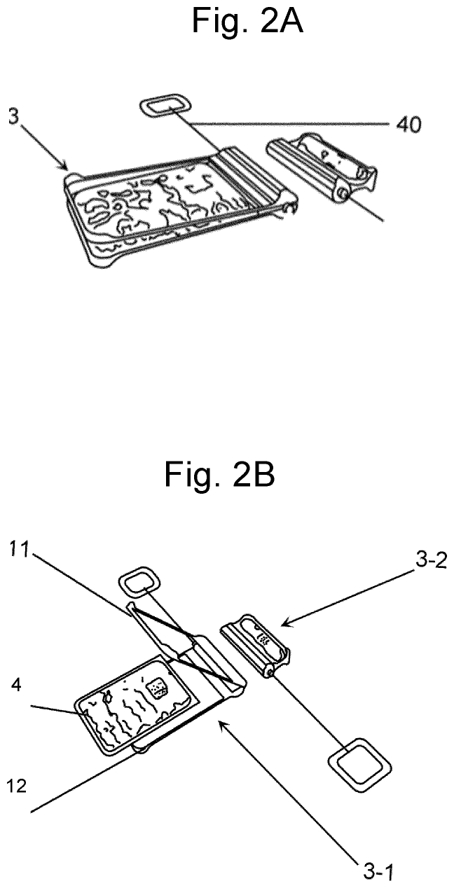

FIGS. 2A and 2B are perspective view of flexible bag units according to the invention.

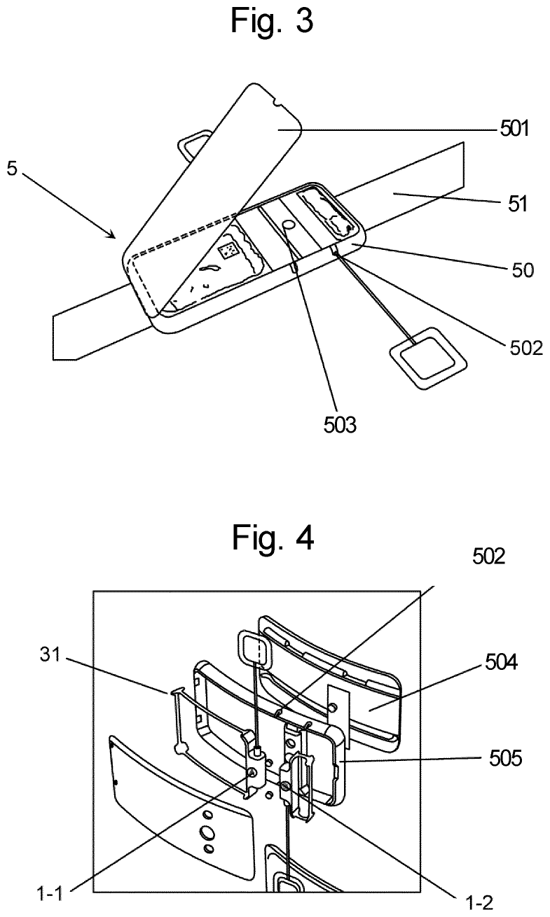

FIG. 3 is a perspective view of a medication delivery device containing a flexible bag unit according to the invention.

FIG. 4 is an exploded view of another medication delivery device according to the invention

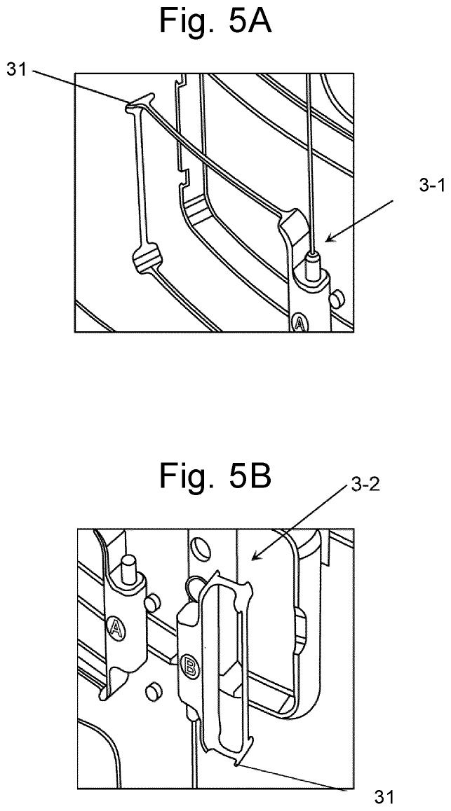

FIGS. 5A and 5B are magnified views of two flexible bag units having different bag volumes, which are accommodated in the medication delivery device of FIG. 4.

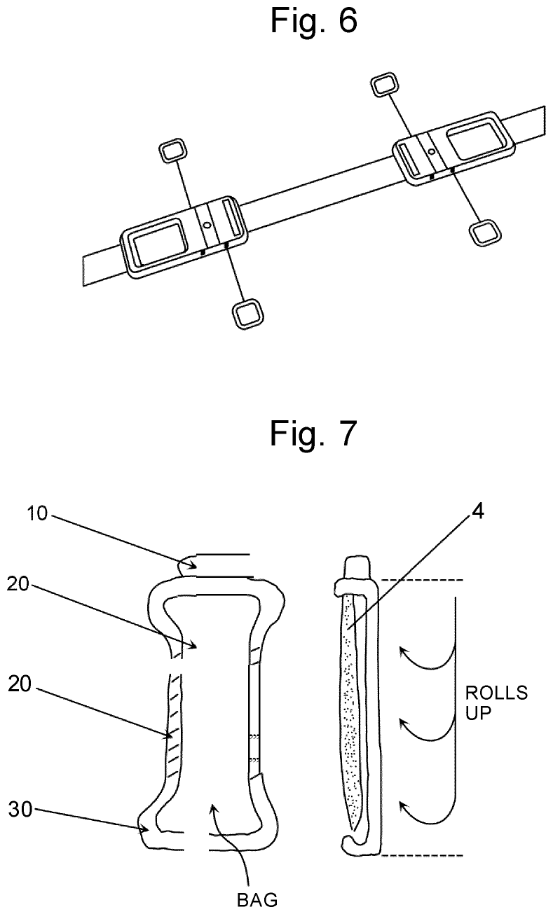

FIG. 6 is a perspective view of two medication delivery devices used together with one fastener according to the invention.

FIG. 7 shows front and side views of a shape-changing support according to the invention.

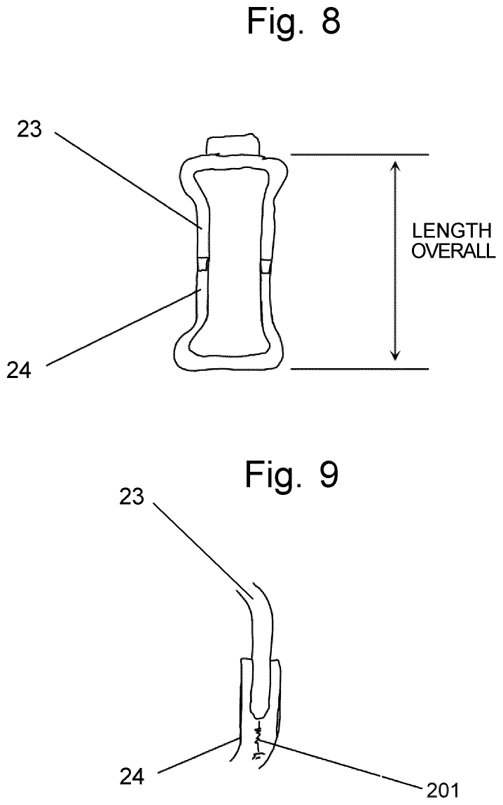

FIG. 8 shows a front view of another shape-changing support according to the invention.

FIG. 9 shows a mechanism for the shape-changing support of FIG. 8.

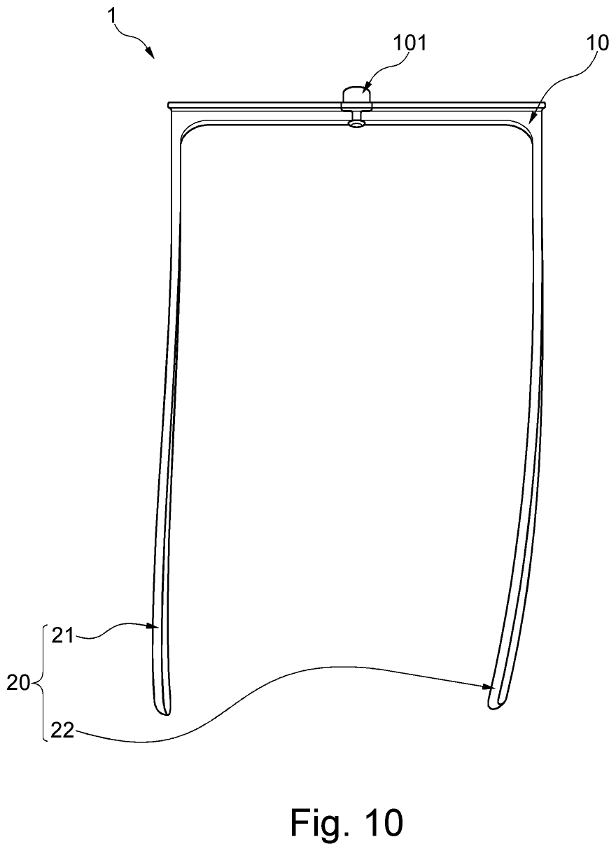

FIG. 10 shows a support according to the invention.

FIGS. 1A to 1F show various alternative supports for a flexible bag according to the present invention, which may cooperate with different medication delivery devices.

Each of the supports 1 of FIGS. 1A to 1F comprises a portion which is fixedly coupled to and tightly hold at least one side of the flexible bag. The support 1 further comprises an outlet 101 connectable with an external tube 40 (see FIG. 2A), and a flow path which fluidly communicates with the outlet 101 and the inner space of the flexible bag 4. Under this configuration, liquid medication in the flexible bag 4 flows from its inner space to the external tube 40 via the outlet 101.

The support 1 may have three portions, i.e. a support head 10 arranged to cover or substantially enclose one side of the flexible bag, a support body 20 extending from the support head 10, and a support leg 30 connected to the support body 20 and arranged to cover or substantially enclose another side of the flexible bag. The outlet 101 and the flow path explained above may be disposed in the support head 10.

In the present disclosure, the term “top” refers to a direction toward the support head 10 from a center of the support 1, and the term “bottom” refers to a direction toward the support leg 30 from the center of the support 1. The terms “left” and “right” refer to opposite directions, which are orthogonal to the top and bottom directions.

The support 1 according to FIGS. 1A, 1C and 1F comprises the support head 10 only. The support 1 according to FIG. 1B comprises the support head 10 and the support body 20. The support 1 according to FIGS. 1D and 1E comprises all the support head 10, the support body 20 and the support leg 30.

The support 1 according to FIGS. 1A, 1C and 1F might be misunderstood as a bigger version of a header of a Weibel bag. One difference of the support 1 over the Weibel bag header is that the support 1 extends along and encloses one complete side of the flexible bag. Thus, in comparison with the Weibel bag, the support 1 can hold the flexible bag more securely and protect the one complete side of the bag more safely.

The support head 10 may have a cross-section of a ‘U’ shape with respect to an imaginary plane extending in the top-bottom direction but being orthogonal to the left-right direction. The one complete side, at least edge, of the flexible bag may be disposed inside the ‘U’-shape support head 10 in the manner that the support head 10 covers both a first surface and an opposite second surface of the flexible bag 4.

A portion of the flexible bag 4 may be fixed to the inner surface of the support head 10 having the ‘U’-shape cross-section by means of glue or any other fixing means such as heat sealing, ultraviolet cured adhesive, overmolding, insert molding, or comolding. Then, the support head 10 may be regarded as to form a portion of the flexible bag 4. In other words, the support head 10 can reinforce or make substantially rigid the portion of the flexible bag 4.

The supports 1 of FIGS. 1A, 1C and 1F are different from each other with respect to how much and in what shape the support head 10 protrudes toward the flexible bag 4.

The support 1 of FIG. 1F has a simple straight end portion protruding toward the flexible bag 4, whereas the supports 1 of FIGS. 1A and 1C have an irregular end portion partially differently protruding toward the flexible bag 4. Specific shapes of the irregular end portion may be designed for user's easy and tight grip of the support head 10. With respect to the user's easy and tight grip, the support 1 of FIGS. 1 and 1C is more advantageous than the support 1 of FIG. 1F.

As shown in FIGS. 2A and 2B, the flexible bag is fixedly coupled to the support head 10. Most of the first surface and the opposite second surface of the flexible bag is visible. In other words, the support 1 is shaped having a visible area which allows users to reliably inspect the entire volume of medication in the flexible bag. Preferably, the support is shaped for allowing more than 50% of either one or both of the first surface and the opposite second surface of the flexible bag to be visible. This enables users to visually inspect a state of liquid medication in the flexible bag prior to use, during delivery, and/or after delivery is complete.

For the support 1 of FIG. 1E, as explained below, where most of the rear surface of the flexible bag is supported by a lower support body 221, it is thus required for reliable inspection that most of the front surface of the flexible bag should be exposed, which allows users to reliably inspect the entire volume of medication in the flexible bag. In case where an inspection window is formed in the lower support body 221, it is preferable that the inspection window amounts to 50% of the lower support body 221. This inspection window facilitates identifying particulates generated within liquid medication. In this case the visible area amounts substantially to 75% of the surfaces of the flexible bag.

Preferably, the non-visible area of the flexible bag may be less than 5% of the surfaces since at least one edge of the flexible bag is substantially enclosed by the support 1.

The support 1 of FIG. 1B comprises the support body 20 extending from the support head 10 toward other side of the flexible bag than the one side of the flexible bag coupled to the support head 10. The support body 20 of the support 1 of FIG. 1B may comprise a first support body 21 and a second support body 22 spaced from each other. The flexible bag 4 may be disposed between the first support body 21 and the second support body 22. The support body 20 may comprise a window 23. This window 23 increases a visible area of the flexible bag. A shape of the window 23 may be designed in many ways having different sizes and shapes, insofar as the visible area allows users to reliably inspect the entire volume of medication in the flexible bag. Preferably the visible area is over at least 50% of the first and second surface of the flexible bag. The design of FIG. 1B can minimize use of the material based on a design of the window 23.

The support head 10 of FIG. 1B may also have a ‘U’-shape cross section, which covers or substantially enclose a rigid top portion or top side of the flexible bag 4.

The design of FIG. 1B enables tightly integrating a flexible bag 4 with the support 1 at the same time of heat sealing a top portion of the flexible bag 4. This is performed by sliding two bag surfaces of the top portion into the support body 20 and then molding the support head 10 with the two bag surfaces. After this molding, the support 1 cannot be disassembled with the flexible bag 4.

The design of FIG. 1B may be more efficient with respect to molding and assembling but reduce the ability to inspect the entire bag. Thus, in the alternative, a lower end of the support body 20, which is away from the support head 10, may have different contours to achieve a balanced level of flexural rigidity and support while maximizing inspection of the entire volume of medication in the flexible bag 4. The design of FIG. 1B may cooperate with a drug delivery device, and the window 23 of the bag 4 can effectuate inspection of a filled flexible bag after assembly into the drug delivery device. This inspection may be performed as pre-administration inspection (e.g., particulate), during medication delivery (e.g., in process monitoring), and/or after delivery is complete.

Notably, the design of FIG. 1B provides partial support to the flexible bag, and primarily reinforces the large flat top surfaces of the flexible bag and does not provide explicit support to all edges of the flexible bag. Such a design prevents excessive flexure, especially of the heat seal surfaces at the bag edges, while reducing the amount of material required for the support.

In contrast, the design of FIG. 1D provides structural support along the entire bag edges and maximizes inspection area of the bag. Like the design of FIG. 1B, the support 1 may selectively reveal or conceal a portion of flexible bag through an inspection window 23 while hiding other portions.

Specifically, the support 1 of FIG. 1D comprises a support head 10 comprising an outlet 101 and being capable of enclosing a top side of a flexible bag, a support body 20 extending from the support 10 and being capable of enclosing left and right sides of the flexible bag, and a support leg 30 connected to the support body 20 and being capable of enclosing a bottom side of the flexible bag 4. The support 1 of FIG. 1D may further comprise the inspection window 23 disposed at least inside the support body 20.

The support body 20 may comprise a first support body 21 and a second support body 22. Different from the design of FIG. 1B, the first and second support bodies 21, 21 are connected to each other to hold the left and right sides of the flexible bag 4. The connected two support bodies 21, 22 forms a ‘U’-shape cross section with respect to an imaginary plane extending in the left-direction but being orthogonal to the top-bottom direction, to cover or substantially enclose the left and right sides, at least edges, of the bag 4. The support leg 30 may also have a 'U'-shape cross section to cover or substantially enclose the bottom side, or at least edge, of the bag 4.

The support 1 of FIG. 1D may have a narrower width (i.e. a distance in the left-right direction) in the support body 20 than in the support head 10 and/or the support head 30. This shape is in line with the shape of a fully filled flexible bag, which has a normal square shape in an empty state. Therefore, this shape enables the support 1 to more securely hold the entire sides, at least edges, of the fully filled bag.

The support 1 of FIG. 1E has a support body 20 formed of a lower support body 221 capable of supporting a flexible bag on one side of the bag. That is, FIG. 1E illustrates a design featuring the lower support body 221, which is a flat backing plate, and open front (i.e., outwardly facing when loaded in a medication delivery device). Thus, the lower support body 221 works for indicating an orientation of the support 1 when the support 1 together with a flexible bag is loaded in a medication delivery device.

The lower support body 221 supports the bag across its entire length in the top-bottom direction.

Since the lower support body 221 allows an entire front surface of flexible bag to be exposed, the structure of FIG. 1E is also good for visual inspection. For better visual inspection, the lower support body 221 may have an inspection window (not shown in the drawings) by removing a portion thereof. Alternatively, the lower support body 221 may have a color which facilitates quick detection of particulates generated in liquid medication.

The design of FIG. 1E may be provided with a co-molded material in the lower support body 221 to conduct body heat from a patient towards the medication, allowing the medication to naturally reach a comfortable injection temperature. Alternatively, the lower support body 221 may be designed to prevent cold temperatures from being felt by a patient, by selecting a material with poor thermal conductance. Similar affordances may be added to the designs of FIGS. 1B and 1D by addition of a separate component within the inspection window of the support 1 if desired.

The support leg 30 of the support 1 of FIG. 1E may also have a ‘U’-shape cross section to cover or substantially enclose the bottom side, at least edge, of the bag 4.

With respect to all supports of FIGS. 1A to 1F, as shown in FIG. 2B, the support 1 may comprise a first support 11 and a second support 12 coupled to the first support 11. The first and second support 11, 12 can be adapted to receive a flexible bag between them. For instance, the first and second supports 11, 12 may be molded with the flexible bag being disposed between them in the manner that the flexible bag cannot be disassembled from the support 1. This molding method comprises injection molding or molding of multiple parts assembled through a fixing means, such as snap-fit, adhesives, ultrasonic welding, etc.

Alternatively, the first and second support 11, 12 are hinge coupled components. After a flexible bag is put on the second support 12, the first support 11 is rotated around the hinge and assembled with the second support 12 together with the bag. This assembly structure allows use of a simple top portion of the bag 4, more similar to the header design of Weibel bags (see above), and may prevent excessive stresses (e.g., as from patient movement) from being transferred to the entire length of the bag header and heat seal.

A portion of the support body 20 of the support in FIGS. 1B, 1D and 1E may be made of a flexible material.

The support of FIGS. 1A to 1F may further comprise a tube 40 connected to the outlet 101 and a needle connected to the tube 40 for supplying the liquid medication to patients. One or more out of the outlet 101, the tube 40 and the needle may be arranged asymmetrically relative to the support head 10 to indicate an orientation of the support 1 and/or a flexible bag 4 coupled to the support 1. For instance, the needle may extend from either side of the support head 10 in an outward direction. This advantageously allows both orientation of flexible bags in a cooperating medication delivery device and positive control over the needle direction exiting the medication delivery device.

The support 1 of FIGS. 1A to 1F may be sculpted or curved to conform a medication delivery device which also has a curved shape, as shown in FIG. 4. This also provides some degree of error-proofing on orientation when the support 1 together with the flexible bag is loaded in the medication delivery device 5.

The support 1 of FIGS. 1A to 1F may have a geometry which can be used to locate a flexible bag unit 3, which comprises said support 1, at a particular position in a specific medication delivery device. For instance, the geometry comprises one or more pins or protrusions 31 formed on the support 1. If the pins or protrusions are formed to protrude symmetrically with each other, as shown in FIG. 4, they can serve to center the flexible bag unit 3 in the specific medication delivery device or to support a cover 501 of a medication delivery device 5 in which the flexible bag unit 3 is contained. The one or more pins or protrusions may be formed at corners or edges of the support 1 to reinforce the support 1 itself and/or support the cover 501 of the device 5.

Although shown in FIGS. 5A and 5B as symmetric, various geometries may be used on each side of the flexible bag to ensure proper orientation. This is particularly advantageous if a curved contour is not used and the need for additional keying cues to a user (or device controller) are needed.

The geometry of the support 1 may works as a key to a specific medication delivery device. In other words, the geometry may be used to activate an electronic sensor or a switch in the drug delivery device.

Further, the geometry may be used to indicate the presence, absence, full insertion, correct orientation, volume capacity, or other relevant information related to a medicament contained within the flexible bag 4 or the flexible bag unit 3 comprising said flexible bag 4 in the medication delivery device.

Further, the geometry of the support 1 may indicate or encode information relating to a flexible bag 4 which can be assembled with the support 1 or the medication filled in the flexible bag. The information relating the flexible bag 4 or the medication may comprise: a capacity of the flexible bag 4, an amount of the medication in the flexible bag 4, one or more parameters associating the medication with a patient receiving the medication with a medication delivery device, one or more parameters for delivery of the medication to patient, other relevant factors, or combinations thereof.

Alternatively, curvature, shape, contour, or presence/absence of one or more geometries may be used in combination to encode information relating to the flexible bag 4 which can be assembled with the support 1 or the medication filled in the bag 4, by cooperating with a sensor and or a switch in the drug delivery device.

The support 1 of FIGS. 1A to 1F may comprise an electronic tag, such as a RFID or NFC tag, for the same or similar purpose as use of the geometry. Specifically, the electronic tag may be used for or contain information for activating an electronic sensor or a switch in the drug delivery device. The information contained in the electronic tag may be used to indicate the presence, absence, full insertion, correct orientation, or volume capacity of the flexible bag 4 or the flexible bag unit 3 in the medication delivery device. The electronic tag may contain the information relating to a flexible bag 4 which can be assembled with the support 1 or the medication filled in the flexible bag, as listed above.

Alternatively, this electric tag may be disposed on a flexible bag 4 assembled with the support 1, not on the support 1.

One or more geometries may be provided with the electronic tag to allow a cooperating medication delivery device to more accurately identify the medicament contained within the bag or more accurately configure one or more delivery parameters of the medication delivery device.

The use of the geometries may be preferable when an electronic tag is impractical or impossible given constraints of the medication delivery device.

FIGS. 2A and 2B illustrate a flexible bag unit 3 comprising a support 1 of FIGS. 1A to 1F together with a flexible bag 4 according to the invention. These figures further illustrate an example of assembling the flexible bag 4 with the support 1. These figures further illustrate how the support 1 of FIG. 1A to 1F may be adapted to different bag sizes. A representative 100 mL bag is shown in the lower left, and a 10 mL bag is shown in the upper left of each figure.

The flexible bag 4 shown in FIGS. 2A and 2B may comprise at least two layers of flexible films sealed at the boundary thereof to form an inner space to accommodate liquid medication. The at least two layers of flexible films constitute the first surface and the opposite second surface of the flexible bag 4. The at least two layers of flexible films may have different rigidity by adopting different materials and/or applying different thickness of a same material. Alternatively, the flexible bag 4 may comprise at least one layer of flexible film and at least one layer of non-flexible material sealed to the at least one layer of flexible film to form an inner space to accommodate liquid medication. The at least one layer of flexible film and the at least one layer of non-flexible material constitute the first surface and the opposite second surface of the flexible bag 4.

In a preferred embodiment, the bag material (i.e., each of the at least two layers) may have a drug contacting layer on the inner side and one or more barrier materials on the outer side, bonded through an intermediary tie layer. In one preferred embodiment, the inner side drug contacting layer is a cyclic olefin copolymer (COC) or a cyclic olefin polymer (COP), and the outer side barrier layer is an Aclar (PCTFE) film.

FIG. 3 illustrates a medication delivery device 5 containing at least one flexible bag unit 3 according to the invention. The medication delivery device 5 comprises at least one flexible bag unit 3 explained above; and a housing 50 comprising one or more inner spaces for accommodating the at least one flexible bag unit 3, a cover 501 to cover the one or more inner spaces, and a coupling portion (not shown) which is connectable with a fastener to fix the housing 50 to the body of a patient.

The housing 50 may comprise a housing body 505 having the one or more inner spaces, and a bottom plate 504 coupled to the housing body 505 and comprising the portion connectable to a fastener 51. The bottom plate 504 may be formed separately from the housing body 505 and then assembled with the housing body 505.

As shown in FIG. 4, the medication delivery device 5 may have a curved shape to conform a body shape relating to medication delivery sites. Flexible bag units 3 having curvature corresponding to the curved shape of the device 5 may be designed for the device 5. The mating curved contours of the medication delivery device 5 and the flexible bag unit 3 facilitates loading the unit 3 at a correct position in the device 5 with ease.

The housing 50 may comprise at least one groove 502 which allows the tube 40 to be inserted therein for use while the cover 501 is closed. In case that one inner space has a plurality of grooves 502, the grooves 502 may be arranged asymmetrically to induce a particular flexible bag unit 3 to be loaded at a desired position in the medication delivery device 5.

The housing 50 may further comprise one or more sensors for detecting one or more geometries of the support 1 and/or communicating with the electronic tag on the support 1 or the flexible bag 4. By the detection of the geometries and/or the communication with the electronic tag, the information encoded by the geometries or contained in the electronic tag can be obtained by the device 5. The one or more sensors and electronic components necessary for operating the sensors may be disposed between the bottom plate 504 and the housing body 505. Since the one or more sensors and the electronic components are not exposed to the outside, they can be protected from liquid spilled on the medication delivery device 5 and a shock applied when the device 5 is mistakenly dropped on the floor.

The housing 50 may further comprise a display 503. Through the display 503, the obtained information and/or notifications determined based on the obtained information may be presented. For instance, the notifications may include a message of informing presence/absence of a particular flexible bag unit 3, notifying incorrect positioning of the particular flexible bag unit 3 in the medication delivery device 5, informing one or more parameters associating the medication in the bag 4 with a patient supposed to receive the medication, or informing one or more parameters for delivery of the medication to patients, but not limited to these kinds of messages.

The display 503 may be disposed on a portion of the housing 50 between two inner spaces for accommodating two flexible bag units 3-1, 3-2.

A portion of the cover 501 corresponding to the display 503 may be more transparent than other portions or have a hole for better visibility of the display 503.

The housing 50 of the medication delivery device 5 of FIG. 3 may have two or more inner spaces for accommodating a large volume flexible bag unit 3-1 and a small volume flexible bag unit 3-2 together. That is, the housing 50 may accommodate the two flexible bag units 3-1, 3-2 of FIGS. 2A and 2B having different bag volumes.

The two or more inner spaces of the housing 50 may be arranged so that the respective supports 1-1, 1-2 of the two flexible bag units 3-1, 3-2 faces each other. This configuration is beneficial in that the tubes 40 and needles of the two units 3-1, 3-2 are disposed close to each other so that users can manage them more carefully to avoid the needles from being mistakenly pulled out from the medication delivery sites.

The cover 501 may be hinge coupled to the housing 50. FIG. 4 shows only one cover to cover the two or more inner spaces at the same time, but an individual cover may be provided for each inner space.

The fastener 51 may be a harness, a shoulder strap, or a belt. As shown in FIGS. 3 and 4, the housing 50 may be arranged with respect to the fastener 51 so that the large volume flexible bag unit 3-1 in the housing 50 is directed upwards (i.e., above the beltline) towards the abdomen site, while the small volume flexible bag unit 3-2 in the housing 50 is directed downwards (i.e., below the beltline) towards the thigh site.

The inner spaces of the housing 50 for the two units 3-1, 3-2 are arranged side by side along the beltline. This arrangement contributes to stably fastening the housing 50 to the body of patient.

The two bag units 3-1, 3-2 may be provided with different tubing length to allow reaching a desired anatomic site based on actual patient anthropometrics.

While FIG. 3 depicts a belt-worn device, other types of a fixing means, such as resilient bands, may be used for the fastener 51.

As shown in FIG. 6, two or more medication delivery devices may share one single fastener 51.

Reusable medication delivery devices have advantages for sustainability and patient convenience. However, they may be used over a long period time with storage in between, as in the home, or may be used frequently across multiple patients, as in the clinic setting. Particularly in the clinic setting, Healthcare-Associated Infections (HAIs) pose risks of increasing patient treatment intensity and cross-transmission. HAIs are associated with longer hospital stays, post-discharge readmission, and higher expenses. As a result, there is a desire to avoid contamination by microbes, viruses, or fungi that may affect sterility of the medications delivered with such a device. Thus, in one or more of the disclosed embodiments, and/or in one or more of the fasteners made of fabric items, such as belts, shoulder straps, or harness, or portions thereof, may be provided with one or more of a persistently antimicrobial, antifungal, or antiviral agent. Areas that may be advantageously provided with such a coating include e.g. waist-worn belt. Such a coating could include fibers woven into the fabric material (e.g., silver fibers), be provided through a secondary coating, spray, or dipping operation, or by selecting an outer fabric layer featuring persistently antimicrobial, antifungal, or antiviral properties. In one or more disclosed embodiments, one or more rigid aspects of the designs, such as outer housings, connection points, or interfacing surfaces for the medication dispensing fluidics are provided with (i.e., molded in, molded with) a compound featuring persistently antimicrobial, antifungal, or antiviral properties. Alternatively, a compound featuring persistently antimicrobial, antifungal, or antiviral properties may be applied to the molded (i.e., finished) components through secondary processes (e.g., chemical vapor deposition), spraying, or dipping processes.

The support 1 of FIGS. 1A to 1F may be constructed, at least partially, with a flexible material with allows selective and predictable movement of the support 1 relative to a filled flexible bag. However, this relative movement of the support 1 is limited to provide sufficient high rigidity of the support 1 to protect the filled flexible bag.

FIGS. 7, 8 and 9 illustrates embodiments of a shape-changing support which allows high bending or relative movement in a desired direction while providing relatively higher resistance to bending or relative movement in undesired directions. This shape-changing support can serve to aid insertion and/or provide protection to (i.e., prevent damage, creasing, or kinking of) the heat seals used to construct a flexible bag.

Portions of the support 1 may be provided with flexures with a predefined flexibility characteristic. Alternatively, the portions of the support 1 may be co-molded with a flexible material (e.g., TPE blend) that provides rigid structural support and balanced flexibility. The portions of the support 1 may be engineered to resist bending forces exerted during handling after filling (extra weight). The portions of the frame may be provided with anisotropic properties or made of anisotropic materials.

As seen in FIG. 7, portions of the support 1 may be formed with a flexible material to contract the support 1 as the flexible bag 4 goes empty. FIG. 7 shows how the flexible portion may be structured to roll up as the flexible bag 4 is evacuated. The bottom rigid portion of the frame may be provided with a visual indicator, as by coloring (pad printing, co-molded) to be seen through a drug delivery device window.

The support body 20 of the support 1 of FIG. 7 may be made of one or more flexible materials. For reliable holding of the flexible bag 4 before and after rolling, the support head 10 and the support leg 30 of the support 1 of FIG. 7 may be made of one or more rigid materials or one or more materials having less flexible than the material of the support body 20. Further, the rigidity of the support body 20 may be lower than that of the support head 10 such that the support body 20 is rollable towards and away from the support head 10. In particular, the rigidity of the support body may be configured such that the support body is rollable towards and away from the support head as a volume of medication in the flexible bag changes.

Portions of the support 1 in FIG. 7 may have different rigidity depending on their positions in order for the support 1 to exert a substantially constant squeezing force on the flexible bag 4 as the rolling of the bag 4 develops. For instance, a top portion of the support body 20 in FIG. 7 has low rigidity than a bottom portion of the support body 20.

To facilitate deformation of the support 1, the support 1 of FIG. 7 may have a relatively larger inspection window 23 than the support 1 of FIGS. 1B and 1D, so that more than 70% of both of the first surface and opposite second surface of the flexible bag may be visible.

A medication delivery device 5, which is used with the support 1 of FIG. 7, is adaptable to the shape changes of the support 1. For instance, this medication delivery device 5 may have a cover 501 made of one or more elastic materials.

As an alternative to the support of FIG. 7, a two-piece sliding support 1 of FIG. 8 may be constructed. The support 1 of FIG. 8 may comprise a first frame part 23 and a second frame part 24 being connected to the first frame part 23 via an elastic element 201. One of the first and second frame parts 23, 24 can be inserted into the other one of the first and second frame parts 23, 24. The degree of the insertion is determined by a force applied to the elastic element 201, and this force is variable depending on volumes of remaining medication in the flexible bag 4 coupled to the support 1.

Specifically, in case the first frame part 23 comprises a top portion of the support body 20, and the second frame part 24 comprises a bottom portion of the support body 20, one of the top and bottom portions can be inserted into the other one of the top and bottom portions. A length of the support body 20 is variable by the relative movement between the top and bottom portions as a volume of the medication in the flexible bag 4 changes.

Thus, the support 1 of FIG. 8 and the flexible bag 4 coupled to the support 1 may have a contracted portion when the bag 4 is unfilled. As filling proceeds, the support 1 expands and the overall length increases. As the bag is emptied during medication delivery to a patient, tension of the elastic element 201 contracts the support 1 and the bag, reducing the overall length of the frame. The elastic element 201 shown in FIG. 9 may be retained by pins on the first and second frame parts 23, 24 but other methods of tensioning, which can avoid allowing the elastic element 201 to be placed under stress while unfilled (e.g., to avoid creep of the tensioning element in storage), may be provided. In contrast with the support 1 of FIG. 7, the support 1 of FIG. 1 is compatible with medication delivery devices 5 used together with the support 1 of FIGS. 1A to 1F. Alternatively, specially-design medication delivery devices 5, a length of which is also variable based on a similar mechanism as shown in FIG. 9, may be used together with the support 1 of FIG. 8.

Portions of the first and second frame parts 23, 24 may be colored (e.g., through pad printing, co-molded colors) to be seen through a window or the cover 501 of the medication delivery device 5. One or more colors on the frames parts 23, 24 can give feedback to users about stages of a medication delivery process, such as start of dose, in process, and end of dose.

FIG. 10 shows a support 1 according to another embodiment of the invention. The support 1 comprises a support head 10. The support head 10 comprises an outlet 101 connectable with an external tube, and a flow path which can fluidly communicate the inner space of a flexible bag with the outlet when said flexible bag is being coupled to the support. The support head 10 extends to fully cover and thus protect one side of the flexible bag. The support 1 further comprises a support body 20 comprising a first support body 21 and a second support body 22 spaced from each other, wherein the flexible bag can be disposed between the first support body 21 and the second support body 22. The first support body 21 and the second support body 22 are legs extending orthogonally from the support head 10. Thus, the sides of the flexible bag are supported and/or covered and/or protected as well.

The medicament delivery devices described herein can be used for the treatment and/or prophylaxis of one or more of many different types of disorders.

Exemplary disorders include, but are not limited to: rheumatoid arthritis, inflammatory bowel diseases (e.g. Crohn's disease and ulcerative colitis), hypercholesterolaemia and/or dyslipidemia, cardiovascular disease, diabetes (e.g. type 1 or 2 diabetes), psoriasis, psoriatic arthritis, spondyloarthritis, hidradenitis suppurativa, Sjogren's syndrome, migraine, cluster headache, multiple sclerosis, neuromyelitis optica spectrum disorder, anaemia, thalassemia, paroxysmal nocturnal hemoglobinuria, hemolytic anaemia, hereditary angioedema, systemic lupus erythematosus, lupus nephritis, myasthenia gravis, Behcet's disease, hemophagocytic lymphohistiocytosis, atopic dermatitis, retinal diseases (e.g., age-related macular degeneration, diabetic macular edema), uveitis, infectious diseases, bone diseases (e.g., osteoporosis, osteopenia), asthma, chronic obstructive pulmonary disease, thyroid eye disease, nasal polyps, transplant, acute hypoglycaemia, obesity, anaphylaxis, allergies, sickle cell disease, Alzheimer's disease, Parkinson's disease, dementia with Lewy bodies, systemic infusion reactions, immunoglobulin E (IgE)-mediated hypersensitivity reactions, cytokine release syndrome, immune deficiencies (e.g., primary immunodeficiency, chronic inflammatory demyelinating polyneuropathy), enzyme deficiencies (e.g., Pompe disease, Fabry disease, Gaucher disease), growth factor deficiencies, hormone deficiencies, coagulation disorders (e.g., hemophilia, von Willebrand disease, Factor V Leiden), and cancer.

Exemplary types of drugs that could be included in the delivery devices described herein include, but are not limited to, small molecules, hormones, cytokines, blood products, enzymes, vaccines, anticoagulants, immunosuppressants, antibodies, antibody-drug conjugates, neutralizing antibodies, reversal agents, radioligand therapies, radioisotopes and/or nuclear medicines, diagnostic agents, bispecific antibodies, proteins, fusion proteins, peptibodies, polypeptides, pegylated proteins, protein fragments, nucleotides, protein analogues, protein variants, protein precursors, protein derivatives, chimeric antigen receptor T cell therapies, cell or gene therapies, oncolytic viruses, or immunotherapies.

Exemplary drugs that could be included in the delivery devices described herein include, but are not limited to, immuno-oncology or bio-oncology medications such as immune checkpoints, cytokines, chemokines, clusters of differentiation, interleukins, integrins, growth factors, coagulation factors, enzymes, enzyme inhibitors, retinoids, steroids, signaling proteins, pro-apoptotic proteins, anti-apoptotic proteins, T-cell receptors, B-cell receptors, or costimulatory proteins.

Exemplary drugs that could be included in the delivery devices described herein include, but are not limited to, those exhibiting a proposed mechanism of action, such as human epidermal growth factor receptor 2(HER-2 ) receptor modulators, interleukin (IL) modulators, interferon (IFN) modulators, complement modulators, glucagon-like peptide-1 (GLP-1) modulators, glucose-dependent insulinotropic polypeptide (GIP) modulators, cluster of differentiation 38(CD38) modulators, cluster of differentiation 22 (CD22) modulators, C1 esterase modulators, bradykinin modulators, C-C chemokine receptor type 4 (CCR4) modulators, vascular endothelial growth factor (VEGF) modulators, B-cell activating factor (BAFF), P-selectin modulators, neonatal Fc receptor (FcRn) modulators, calcitonin gene-related peptide (CGRP) modulators, epidermal growth factor receptor (EGFR) modulators, cluster of differentiation 79B (CD79B) modulators, tumor-associated calcium signal transducer 2(Trop-2 ) modulators, cluster of differentiation 52(CD52) modulators, B-cell maturation antigen (BCMA) modulators, enzyme modulators, platelet-derived growth factor receptor A (PDGFRA) modulators, cluster of differentiation 319 (CD319 or SLAMF7) modulators, programmed cell death protein 1 and programmed death-ligand 1 (PD-1/PD-L1) inhibitors/modulators, B-lymphocyte antigen cluster of differentiation 19 (CD19) inhibitors, B-lymphocyte antigen cluster of differentiation 20 (CD20) modulators, cluster of differentiation 3 (CD3) modulators, cytotoxic T-lymphocyte-associated protein 4 (CTLA-4) inhibitors, T-cell immunoglobulin and mucin-domain containing-3 (TIM-3) modulators, T cell immunoreceptor with Ig and ITIM domains (TIGIT) modulators, V-domain Ig suppressor of T cell activation (VISTA) modulators, indoleamine 2,3-dioxygenase (IDO or INDO) modulators, poliovirus receptor-related immunoglobulin domain-containing protein (PVRIG) modulators, lymphocyte-activation gene 3 (LAG3; also known as cluster of differentiation 223 or CD223) antagonists, cluster of differentiation 276 (CD276 or B7-H3) antigen modulators, cluster of differentiation 47 (CD47) antagonists, cluster of differentiation 30 (CD30) modulators, cluster of differentiation 73(CD73) modulators, cluster of differentiation 66(CD66) modulators, cluster of differentiation w137(CDw137) agonists, cluster of differentiation 158(CD158) modulators, cluster of differentiation 27(CD27) modulators, cluster of differentiation 58 (CD58) modulators, cluster of differentiation 80(CD80) modulators, cluster of differentiation 33(CD33) modulators, cluster of differentiation 159 (CD159 or NKG2) modulators, glucocorticoid-induced TNFR-related (GITR) protein modulators, Killer Ig-like receptor (KIR) modulators, growth arrest-specific protein 6 (GAS6)/AXL pathway modulators, A proliferation-inducing ligand (APRIL) receptor modulators, human leukocyte antigen (HLA) modulators, epidermal growth factor receptor (EGFR) modulators, B-lymphocyte cell adhesion molecule modulators, cluster of differentiation w123 (CDw123) modulators, Erbb2 tyrosine kinase receptor modulators, endoglin modulators, mucin modulators, mesothelin modulators, hepatitis A virus cellular receptor 2(HAVCR2) antagonists, cancer-testis antigen (CTA) modulators, tumor necrosis factor receptor superfamily, member 4 (TNFRSF4 or OX40) modulators, adenosine receptor modulators, inducible T cell co-stimulator (ICOS) modulators, cluster of differentiation 40 (CD40) modulators, tumor-infiltrating lymphocytes (TIL) therapies, or T-cell receptor (TCR) therapies.

Exemplary drugs that could be included in the delivery devices described herein include, but are not limited to: etanercept, abatacept, adalimumab, evolocumab, exenatide, secukinumab, erenumab, galcanezumab, fremanezumab-vfrm, alirocumab, methotrexate (amethopterin), tocilizumab, interferon beta-1a, interferon beta-1b, peginterferon beta-1a, sumatriptan, darbepoetin alfa, belimumab, sarilumab, semaglutide, dupilumab, reslizumab, omalizumab, glucagon, epinephrine, naloxone, insulin, amylin, vedolizumab, eculizumab, ravulizumab, crizanlizumab-tmca, certolizumab pegol, satralizumab, denosumab, romosozumab, benralizumab, emicizumab, tildrakizumab, ocrelizumab, ofatumumab, natalizumab, mepolizumab, risankizumab-rzaa, ixekizumab, and immune globulins.

Exemplary drugs that could be included in the delivery devices described herein may also include, but are not limited to, oncology treatments such as ipilimumab, nivolumab, pembrolizumab, atezolizumab, durvalumab, avelumab, cemiplimab, rituximab, trastuzumab, ado-trastuzumab emtansine, fam-trastuzumab deruxtecan-nxki, pertuzumab, transtuzumab-pertuzumab, alemtuzumab, belantamab mafodotin-blmf, bevacizumab, blinatumomab, brentuximab vedotin, cetuximab, daratumumab, elotuzumab, gemtuzumab ozogamicin, 90-Yttrium-ibritumomab tiuxetan, isatuximab, mogamulizumab, moxetumomab pasudotox, obinutuzumab, ofatumumab, olaratumab, panitumumab, polatuzumab vedotin, ramucirumab, sacituzumab govitecan, tafasitamab, or margetuximab.

Exemplary drugs that could be included in the delivery devices described herein include “generic” or biosimilar equivalents of any of the foregoing, and the foregoing molecular names should not be construed as limiting to the “innovator” or “branded” version of each, as in the non-limiting example of innovator medicament adalimumab and biosimilars such as adalimumab-afzb, adalimumab-atto, adalimumab-adbm, and adalimumab-adaz.

Exemplary drugs that could be included in the delivery devices described herein also include, but are not limited to, those used for adjuvant or neoadjuvant chemotherapy, such as an alkylating agent, plant alkaloid, antitumor antibiotic, antimetabolite, or topoisomerase inhibitor, enzyme, retinoid, or corticosteroid. Exemplary chemotherapy drugs include, by way of example but not limitation, 5-fluorouracil, cisplatin, carboplatin, oxaliplatin, doxorubicin, daunorubicin, idarubicin, epirubicin, paclitaxel, docetaxel, cyclophosphamide, ifosfamide, azacitidine, decitabine, bendamustine, bleomycin, bortezomib, busulfan, cabazitaxel, carmustine, cladribine, cytarabine, dacarbazine, etoposide, fludarabine, gemcitabine, irinotecan, leucovorin, melphalan, methotrexate, pemetrexed, mitomycin, mitoxantrone, temsirolimus, topotecan, valrubicin, vincristine, vinblastine, or vinorelbine.

Exemplary drugs that could be included in the delivery devices described herein also include, but are not limited to, analgesics (e.g., acetaminophen), antipyretics, corticosteroids (e.g. hydrocortisone, dexamethasone, or methylprednisolone), antihistamines (e.g., diphenhydramine or famotidine), antiemetics (e.g., ondansetron), antibiotics, antiseptics, anticoagulants, fibrinolytics (e.g., recombinant tissue plasminogen activator [r-TPA]), antithrombolytics, or diluents such as sterile water for injection (SWFI), 0.9% Normal Saline, 0.45% normal saline, 5% dextrose in water, 5% dextrose in 0.45% normal saline, Lactated Ringer's solution, Heparin Lock Flush solution, 100 U/mL Heparin Lock Flush Solution, or 5000 U/mL Heparin Lock Flush Solution.

Pharmaceutical formulations including, but not limited to, any drug described herein are also contemplated for use in the delivery devices described herein, for example pharmaceutical formulations comprising a drug as listed herein (or a pharmaceutically acceptable salt of the drug) and a pharmaceutically acceptable carrier. Such formulations may include one or more other active ingredients (e.g., as a combination of one or more active drugs), or may be the only active ingredient present, and may also include separately administered or co-formulated dispersion enhancers (e.g. an animal-derived, human-derived, or recombinant hyaluronidase enzyme), concentration modifiers or enhancers, stabilizers, buffers, or other excipients.

Exemplary drugs that could be included in the delivery devices described herein include, but are not limited to, a multi-medication treatment regimen such as AC, Dose-Dense AC, TCH, GT, EC, TAC, TC, TCHP, CMF, FOLFOX, mFOLFOX6, mFOLFOX7, FOLFCIS, CapeOx, FLOT, DCF, FOLFIRI, FOLFIRINOX, FOLFOXIRI, IROX, CHOP, R-CHOP, RCHOP-21, Mini-CHOP, Maxi-CHOP, VR-CAP, Dose-Dense CHOP, EPOCH, Dose-Adjusted EPOCH, R-EPOCH, CODOX-M, IVAC, HyperCVAD, R-HyperCVAD, SC-EPOCH-RR, DHAP, ESHAP, GDP, ICE, MINE, CEPP, CDOP, GemOx, CEOP, CEPP, CHOEP, CHP, GCVP, DHAX, CALGB 8811, HIDAC, MOPAD, 7+3, 5+2, 7+4, MEC, CVP, RBAC500, DHA-Cis, DHA-Ca, DHA-Ox, RCVP, RCEPP, RCEOP, CMV, DDMVAC, GemFLP, ITP, VIDE, VDC, VAI, VDC-IE, MAP, PCV, FCR, FR, PCR, HDMP, OFAR, EMA/CO, EMA/EP, EP/EMA, TP/TE, BEP, TIP, VIP, TPEx, ABVD, BEACOPP, AVD, Mini-BEAM, IGEV, C-MOPP, GCD, GEMOX, CAV, DT-PACE, VTD-PACE, DCEP, ATG, VAC, VelP, OFF, GTX, CAV, AD, MAID, AIM, VAC-IE, ADOC, or PE. Other aspects, features, and advantages will be apparent from the summary above, as well as from the description that follows, including the figures and the claims.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

Furthermore, in the claims the word “comprising” does not exclude other elements or steps, and the indefinite article “a” or “an” does not exclude a plurality. A single unit may fulfil the functions of several features recited in the claims. The terms “essentially”, “about”, “approximately” and the like in connection with an attribute or a value particularly also define exactly the attribute or exactly the value, respectively. Any reference signs in the claims should not be construed as limiting the scope.

1-14. (canceled)

15. A support for a flexible bag, said flexible bag having an inner space to accommodate a volume of liquid medication,
the support i) being adapted to fixedly couple to and tightly hold at least one side of the flexible bag, ii) comprising an outlet connectable with an external tube, and a flow path which can fluidly communicate the inner space of the flexible bag with the outlet when said flexible bag is being coupled to the support, and iii) extending to fully cover and thus protect at least one side of the flexible bag, the support allowing at least a part of the flexible bag to be visible when said flexible bag is being coupled to the support.

16. The support according to claim 15, wherein the support comprises a support head having the outlet and the flow path; and a support body extending from the support head.

17. The support according to claim 16, wherein the support body comprises a first support body and a second support body spaced from each other, wherein the flexible bag can be disposed between the first support body and the second support body.

18. The support according to claim 17, wherein the support further comprises a support leg connected to the first support body and to the second support body and arranged to enclose a side of the flexible bag other than the at least one side of the flexible bag to cover and thus protect.

19. The support according to claim 16, wherein the support body comprises a lower support body adapted to support the flexible bag on one side of the flexible bag when said flexible bag is being coupled to the support, and
wherein the support preferably further comprises a support leg connected to the lower support body and arranged to cover a side of the flexible bag other than the at least one side of the flexible bag to cover and thus protect.

20. The support according to claim 16, wherein a width of the support body is smaller than the width of the support head, and
wherein the support body has a cross-section of a ‘U’ shape to partially cover both a first surface and an opposite second surface of the flexible bag.

21. The support according to claim 15, wherein the rigidity of the support body is lower than the rigidity of the support head such that the support body is rollable towards and away from the support head as a volume of medication in the flexible bag changes when said flexible bag is being coupled to the support.

22. The support according to claim 16, wherein the support comprises a first support and a second support coupled to each other, preferably by means of a hinge, wherein the first and second supports are adapted to receive the flexible bag in between.

23. The support according to claim 16, wherein the support body comprises a first frame part and a second frame part connected to each other such that a length of the support body is variable by a relative movement between the first and second frame parts as a volume of medication in the flexible bag changes when said flexible bag is being coupled to the support, so that the support body has a contracted position and an expanded position.

24. The support according to claim 15, further comprising a tube connected to the outlet and a needle connected to the tube for supplying the liquid medication to patients.

25. The support according to claim 24, wherein one or more out of the outlet, the tube and the needle are arranged asymmetrically relative to the support head to indicate an orientation of the support.

26. A flexible bag unit comprising the support according to claim 15 and a flexible bag filled with medication.

27. The flexible bag unit according to claim 26, wherein the flexible bag comprises an electronic tag containing information relating to the flexible bag or to the medication filled in the flexible bag.

28. A medication delivery device comprising:
at least one flexible bag unit according to claim 26; and
a housing comprising one or more spaces for accommodating the at least one flexible bag unit, a cover to close the one or more spaces, and a coupling portion which is connectable to a fastener for fixing the housing to a body part of a patient.
